(19) United States
(12) Patent Application Publication
(10) Pub. No.: US 2020/0216063 A1
(43) Pub. Date: Jul. 9, 2020

(54) VEHICLE AND METHOD FOR CONTROLLING THE SAME

(71) Applicants: Hyundai Motor Company, Seoul (KR); Kia Motors Corporation, Seoul (KR)

(72) Inventors: Hyung Jun Lim, Yangpyeong (KR); JuYun Ro, Suwon (KR); Jeong-Jae Yoo, Incheon (KR)

(21) Appl. No.: 16/380,554

(22) Filed: Apr. 10, 2019

(30) Foreign Application Priority Data
Jan. 9, 2019 (KR) 10-2019-0002590

(51) Int. Cl. B60W 30/095; B60Q 9/00; G08G 1/16; B60W 30/09; G01S 13/93

(52) U.S. Cl. CPC B60W 30/0956; B60Q 9/005; G08G 1/167; G08G 1/166; B60W 30/09; B60Q 9/006; B60W 2420/52; G01S 13/931; B60R 2300/105; B60R 2300/804; B60R 2300/8093; B60W 2420/42; B60Q 9/008

(57) ABSTRACT

A vehicle and a method for performing collision avoidance when a parked vehicle exits while driving in parallel with another vehicle are provided. The vehicle includes a capturer that detects a parking line in which the vehicle is parked and a sensor that detects an obstacle on at least one of a front and rear side of the vehicle and detects a target vehicle approaching from a rear lateral side of the vehicle. A controller determines a driving type of the vehicle based on the parking line information, the obstacle information, and the target vehicle information to determine a risk of collision region of the vehicle based on the driving type. The controller determines an expected collision region between the vehicles within the risk of collision region based on driving information of the vehicles to change the driving control amount of the vehicle according to the expected collision region.

### CROSS-REFERENCE TO RELATED APPLICATION(S)

This application is based on and claims priority under 35 U.S.C. § 119 to Korean Patent Application No. 10-2019-0002590, filed on Jan. 9, 2019, the disclosure of which is incorporated by reference in its entirety.

### TECHNICAL FIELD

The present disclosure relates to a vehicle and a method for controlling the same, and more particularly, to a technology for performing collision avoidance control when a parked vehicle exits a parking area while driving in parallel with another vehicle approaching in a side lane, and a method for controlling the vehicle.

### BACKGROUND

Generally, vehicles are driven on roads or tracks to transport people or goods to destinations. Vehicles are able to move to various locations on one or more wheels mounted onto the frame of the vehicle. Such vehicles may be classified into three- or four-wheel vehicles, a two-wheel vehicle such as a motorcycle, construction machinery, bicycles, trains traveling along rails on tracks, and the like. With the development of automotive technology, there are advantages of traveling long distances but problems also often arise in traffic conditions worsen and traffic jams increase where population densities are high.

To relieve burdens and increase convenience of a driver, recent studies regarding vehicles equipped with an Advanced Driver Assist System (ADAS) that actively provides information regarding a state of the vehicle, a state of the driver, and surrounding conditions are actively ongoing. Examples of the ADAS equipped within the vehicle include Rear Cross-Traffic Collision Warning (RCCW) and Rear Cross-Traffic Collision-Avoidance Assist (RCCA). The RCCA is a system that prevents collision by performing brake braking control of the vehicle based on collision determination contents detected by a sensor mounted on the vehicle when a risk of collision is determined by not recognizing the driver's inattention or a cross-approaching vehicle in a blind spot while the vehicle is driving rearward.

In other words, the conventional RCCA prevents collision by braking during risk conditions when another vehicle approaches by recognizing a vehicle cross-approaching from a rear lateral side by a rear lateral side radar sensor. However, when an approach angle of a vehicle approaching from the rear lateral side is substantially parallel to the subject vehicle, collision is unable to be prevented since the subject vehicle is unable to detect the approaching vehicle as a collision risk vehicle.

### SUMMARY

Therefore, the present disclosure provides a vehicle for performing collision avoidance control under special conditions in which a parked vehicle exits a parking area while driving in parallel with another vehicle approaching in a side lane and preventing erroneous control conditions that may occur during driving of the vehicle, and a method for controlling the same. Additional aspects of the disclosure will be set forth in part in the description which follows and, in part, will be obvious from the description, or may be learned by practice of the disclosure.

In accordance with an aspect of the present disclosure, a vehicle may include: a capturer configured to detect a parking line in which the vehicle is parked; a sensor configured to detect an obstacle on at least one of a front side and a rear side of the vehicle, and to detect a target vehicle approaching from a rear lateral side of the vehicle; and a controller configured to determine a driving type of the vehicle based on parking line information detected by the capturer, the detected obstacle information, and the detected target vehicle information, to determine a risk of collision region of the vehicle based on the driving type, and to determine an expected collision region between the vehicle and the target vehicle within the risk of collision region based on driving information of the vehicle and driving information of the target vehicle to change the driving control amount of the vehicle based on the expected collision region.

Additionally, the controller may be configured to determine the driving type of the vehicle as the vehicle parked in the detected parking line drives out of the parking line when the capturer detects the parking line in which the vehicle is parked and the sensor detects the obstacle and the target vehicle. The controller may be configured to determine the driving type of the vehicle as a state of driving and not parking when the capturer does not detect the parking line in which the vehicle was parked, the sensor does not detect the obstacle, and the sensor detects the target vehicle. The controller may also be configured to determine the risk of collision region of the vehicle based on a steering angle of the vehicle that varies depending on the driving type of the vehicle and a driving path of the target vehicle approaching from the rear lateral side of the vehicle. The driving path of the target vehicle may be determined based on whether the obstacle is located on the rear side of the vehicle.

The driving information of the vehicle may include an expected driving path of the vehicle and a driving speed of the vehicle. The driving information of the target vehicle may include an expected driving path of the target vehicle and a driving speed of the target vehicle. The controller may be configured to determine the expected driving path of the vehicle based on a steering angle of the vehicle, and determine the expected driving path of the target vehicle based on a change in the real-time position of the target vehicle detected by the sensor.

The vehicle may further include a speed regulator configured to regulate a driving speed of the vehicle. When the expected collision region between the vehicle and the target vehicle within the risk of collision region is determined, the controller may be configured to operate the speed regulator to decrease the driving speed at which the vehicle drives in the determined expected collision region. When the expected collision region between the vehicle and the target vehicle within the risk of collision region is determined, the controller may be configured to increase the driving braking amount of the vehicle within the determined expected collision region beyond a predetermined value.

When the expected collision region between the vehicle and the target vehicle within the risk of collision region is determined, the controller may be configured to advance a collision warning time for the vehicle by a predetermined time. Additionally, the vehicle may include a speed detector configured to detect a driving speed of the vehicle; and a steering angle detector configured to detect a rotation angle of a steering wheel of the vehicle. The obstacle may include other vehicles parked on at least one of the front side and the rear side of the vehicle.

In accordance with another aspect of the present disclosure, a method for controlling a vehicle may include: detecting a parking line in which the vehicle is parked; detecting an obstacle on at least one of a front side and a rear side of the vehicle; detecting a target vehicle approaching from a rear lateral side of the vehicle; determining a driving type of the vehicle based on the detected parking line information, the detected obstacle information, and the detected target vehicle information; determining a risk of collision region of the vehicle based on the driving type; determining an expected collision region between the vehicle and the target vehicle within the risk of collision region based on driving information of the vehicle and driving information of the target vehicle; and changing the driving control amount of the vehicle based on the determined expected collision region.

The determining of the driving type of the vehicle may include determining the driving type of the vehicle as the vehicle parked in the detected parking line drives out of the parking line when the parking line in which the vehicle is parked is detected and the obstacle and the target vehicle are detected. The determining of the driving type of the vehicle may include determining the driving type of the vehicle as a state of driving and not parking when the parking line in which the vehicle was parked is not detected, the obstacle is not detected, and the target vehicle is detected.

The determining of the risk of collision region of the vehicle may include determining the risk of collision region of the vehicle based on a steering angle of the vehicle that varies based on the driving type of the vehicle and a driving path of the target vehicle approaching from the rear lateral side of the vehicle. The driving path of the target vehicle may be determined based on whether the obstacle is located on the rear side of the vehicle.

The driving information of the vehicle may include an expected driving path of the vehicle and a driving speed of the vehicle. The driving information of the target vehicle may include an expected driving path of the target vehicle and a driving speed of the target vehicle. The method may further include determining the expected driving path of the vehicle based on a steering angle of the vehicle; and determining the expected driving path of the target vehicle based on a change in the real-time position of the detected target vehicle.

The method may further include regulating a driving speed of the vehicle. The changing of the driving control amount of the vehicle may include decreasing the driving speed at which the vehicle drives in the determined expected collision region when the expected collision region between the vehicle and the target vehicle within the risk of collision region is determined. The changing of the driving control amount of the vehicle may include increasing the driving braking amount of the vehicle within the determined expected collision region beyond a predetermined value when the expected collision region between the vehicle and the target vehicle within the risk of collision region is determined.

The method may further include advancing a collision warning time for the vehicle by a predetermined time when the expected collision region between the vehicle and the target vehicle within the risk of collision region is determined. The method may further include detecting a driving speed of the vehicle; and detecting a rotation angle of a steering wheel of the vehicle.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a view illustrating a vehicle provided with a sensor and a rear lateral side sensor according to an exemplary embodiment of the present disclosure;

FIG. 2 is a view illustrating that the vehicle being parked is driving out of a parking line according to an exemplary embodiment of the present disclosure;

FIG. 3 is a control block diagram of the vehicle according to an exemplary embodiment of the present disclosure;

FIG. 4 is a flowchart illustrating a method for controlling the vehicle according to an exemplary embodiment of the present disclosure;

FIG. 5 is a view illustrating determining a risk of collision region of the vehicle when the vehicle is driving out of the parking line according to an exemplary embodiment of the present disclosure;

FIG. 6 is a view illustrating determining an expected collision region between the vehicle and a target vehicle within the risk of collision region of FIG. 5 according to an exemplary embodiment of the present disclosure;

FIG. 7 is a view illustrating determining the risk of collision region of the vehicle when a non-parked vehicle is driving according to an exemplary embodiment of the present disclosure;

FIG. 8 is a view illustrating determining the expected collision region between the vehicle and the target vehicle within the risk of collision region of FIG. 7 according to an exemplary embodiment of the present disclosure;

FIG. 9 is a view illustrating determining the risk of collision region of the vehicle when the vehicle makes a left turn or a U-turn according to an exemplary embodiment of the present disclosure;

FIG. 10 is a view illustrating determining the expected collision region between the vehicle and the target vehicle within the risk of collision region of FIG. 9 according to an exemplary embodiment of the present disclosure; and

FIG. 11 is a view illustrating determining the expected collision region between the vehicle and the target vehicle within the risk of collision region of FIG. 9 according to another exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Like reference numerals refer to like elements throughout the specification. Not all elements of exemplary embodiments of the present disclosure will be described, and description of what are commonly known in the art or what overlap each other in the embodiments will be omitted. The terms as used throughout the specification, such as “˜part,” “˜module,” “˜member,” “˜block,” etc., may be implemented in software and/or hardware, and a plurality of “˜parts,” “˜modules,” “˜members,” or “˜blocks” may be implemented in a single element, or a single “˜part,” “˜module,” “˜member,” or “˜block” may include a plurality of elements.

It will be understood that when an element is referred to as being “connected” to another element, it can be directly or indirectly connected to the other element, wherein the indirect connection includes “connection via a wireless communication network.” It will be understood that, although the terms first, second, third, etc., may be used herein to describe various elements, it should not be limited by these terms. These terms are only used to distinguish one element from another element. An identification code is used for the convenience of the description but is not intended to illustrate the order of each step. Each of the steps may be implemented in an order different from the illustrated order unless the context clearly indicates otherwise.

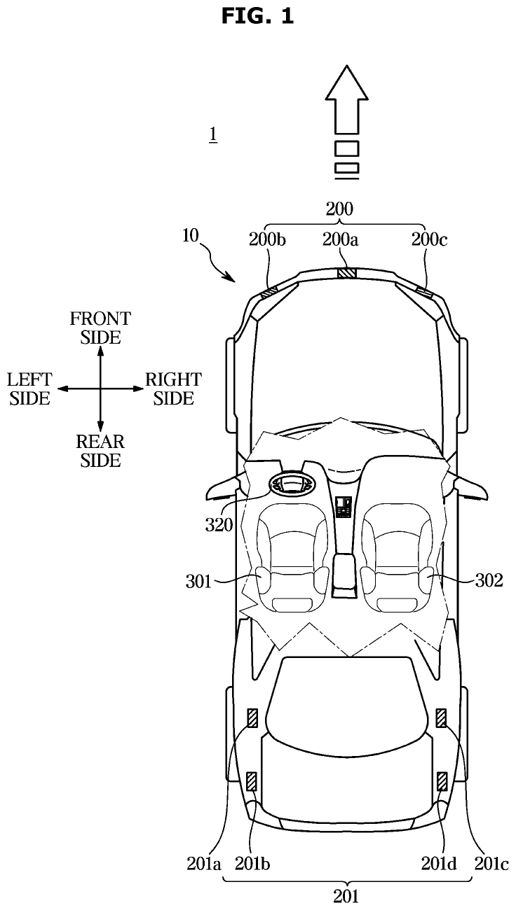

The principle and exemplary embodiments of the present disclosure will now be described with reference to the accompanying drawings. FIG. 1 is a view illustrating a vehicle provided with a sensor and a rear lateral side sensor according to an exemplary embodiment.

Hereinafter for convenience of description, a direction in which a vehicle 1 drives forward may be defined as the front side, and the left direction and the right direction may be defined with respect to the front side. When the front side is a 12 o'clock direction, a 3 o'clock direction or in the vicinity of the 3 o'clock direction may be defined as the right direction and a 9 o'clock direction or in the vicinity of the 9 o'clock direction may be defined as the left direction. A direction opposite to the front side may be defined as the rear side. A bottom direction with respect to the vehicle 1 may be defined as the lower side and a direction opposite to the lower side may be defined as the upper side. Additionally, a surface disposed on the front side may be defined as a front surface, a surface disposed on the rear side may be defined as a rear surface, and a surface disposed on the lateral side may be defined as a side surface. Furthermore, a side surface in the left direction may be defined as a left surface and a side surface in the right direction may be defined as a right surface.

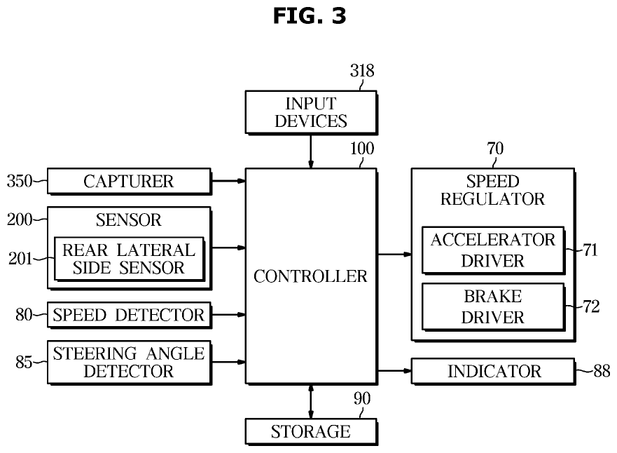

Although not illustrated in FIG. 1, at least one capturer 350 (see FIG. 3) may be disposed inside the vehicle 1. The capturer 350 may be a camera, video camera, or the like and may be configured to capture an image around the vehicle 1 while the vehicle 1 is being driven or stopped, and may be configured to obtain information related to a type and position of an object. The object captured in the image around the vehicle 1 may include another vehicle (e.g., a surrounding vehicle), a pedestrian, a bicycle, etc., and may include a moving object or various stationary obstacles.

The capturer 350 may be configured to detect the type of the object around the vehicle 1 by capturing an image of the object and identifying a shape of the captured object through image recognition, and may be configured to transmit the detected information to a controller 100 (see FIG. 3). In addition, the capturer 350 may be configured to detect a shape of a road or a parting line or the like displayed on the road by capturing the road around the vehicle 1. In other words, the capturer 350 may be configured to detect a driving lane of the road on which the vehicle 1 is being driven or detect a parking area where the vehicle 1 is parked by capturing an image of the lane or parking line displayed on the road. The capturer 350 may be disposed at any location of the vehicle that allows the capturer 350 to obtain image information by capturing the inside or outside of the vehicle 1. The capturer 350 may include at least one camera, and may further include a three dimensional (3D) space recognition sensor, a radar sensor, an ultrasound sensor, etc., to capture a more accurate image.

Referring to FIG. 1, a sensor 200 may be disposed within the vehicle 1. The sensor 200 may be configured to detect the object located in front of the vehicle 1 and obtain at least one of position information and driving speed information of the detected object. As will be described later, the sensor 200 may be configured to detect the obstacle located in front of the vehicle 1. When the vehicle 1 is parked, the sensor 200 may be configured to detect another vehicle parked in front of the vehicle 1.

According to an exemplary embodiment, the sensor 200 may be configured to obtain at least one of position information and driving speed information of the object located around of the vehicle 1 with respect to the vehicle 1. In other words, the sensor 200 may be configured to obtain coordinate information, which changes as the object moves, in real time, and detect a distance between the vehicle 1 (e.g., subject vehicle) and the object. The controller 100 (see FIG. 3) may be configured to calculate a relative distance and a relative speed between the vehicle 1 and the object based on the position and speed information of the object obtained by the sensor 200, and thus, the controller 100 may be configured to calculate a time to collision (TTC) between the vehicle 1 and the object based on the calculated relative distance and relative speed.

Furthermore, the steering of the vehicle may be adjusted to avoid the object and the adjustment may be based on the position and speed information of the object obtained by the sensor 200. As illustrated in FIG. 1, the sensor 200 may be installed in a position that is appropriate to detect an object, e.g. other vehicle, in the front, lateral or front lateral side. According to an exemplary embodiment, the sensor 200 may be installed at the front, the left and the right side of the vehicle 1 to detect an object in the front side of the vehicle 1, a direction between the left side and the front side (hereinafter, referred to as “front left side”) of the vehicle 1 and a direction between the right side and the front side (hereinafter, referred to as “front right side”) of the vehicle 1.

For example, a first sensor 200a may be installed as a part of a radiator grill 6, e.g., inside of the radiator grill 6, or alternatively the first sensor 200a may be installed in any position of the vehicle 1 suitable for detecting another vehicle located in front of the vehicle 1. However, according to an exemplary embodiment, it will be described that the first sensor 200a is installed in the center of the front surface of the vehicle. A second sensor 200b may be installed in the left side of the vehicle 1, and a third sensor 200c may be installed in the right side of the vehicle 1 (e.g., subject vehicle), but the present disclosure is not limited thereto.

The sensor 200 may include a rear lateral side sensor 201 configured to detect a pedestrian or other vehicle that is present or approaching from the rear side, lateral side or a direction between the lateral side and the rear side (hereinafter referred to as a “rear lateral side”) of the vehicle. As illustrated in FIG. 1, the rear lateral side sensor 201 may be installed in a position that is appropriate to detect an object, e.g. other vehicle, on the lateral side, rear side or rear lateral side of the subject vehicle. As will be described later, the rear lateral side sensor 201 may be configured to detect another vehicle approaching from the rear lateral side of the subject vehicle 1 and detect another vehicle parked on the rear side of the subject vehicle 1 when the subject vehicle 1 is parked.

The sensor 200 may be implemented using a variety of devices, e.g., a radar using millimeter waves or microwaves, Light Detection And Ranging (LiDAR) using pulsed laser light, a vision sensor using visible light, an infrared sensor using infrared light, or an ultrasonic sensor using ultrasonic waves. The sensor 200 may be implemented using any one of the radar, the Light Detection And Ranging (LiDAR), the vision sensor, the infrared sensor, or the ultrasonic sensor or by combining them. When a plurality of the sensors 200 is disposed within the vehicle 1, each of the sensors 200 may be implemented by using the same type of sensor or different type of sensor. The implementation of the sensor 200 is not limited thereto, and the sensor 200 may be implemented using a variety of devices and a combination thereof which is considered by a designer.

Furthermore, a display may be installed on an upper panel of a dashboard (not shown) of the vehicle 1. The display may be configured to output a variety of information in the form of images to a driver or passengers of the vehicle 1. For example, the display may be configured to visually output various information, such as maps, weather, news, various moving or still images, information regarding a status or operation of the vehicle 1, e.g., information regarding the air conditioner, etc. The display may also be configured to provide the driver or passengers with an alert that indicates a level of danger to the vehicle 1 (e.g., a notification regarding a collision risk).

A center fascia (not shown) may be installed in the middle of the dashboard, and may include input devices 318 (318a to 318c) for receiving various instructions related to the vehicle 1. The input devices 318a to 318c may be implemented with mechanical buttons, switches, knobs, touch pad, touch screen, stick-type manipulation device, trackball, or the like. The driver may control many different operations of the vehicle 1 by manipulating the input devices 318a to 318c.

A control stand and an instrument panel may be disposed in front of a driver's seat. The control stand may be rotated in a particular direction by manipulation of the driver, and accordingly, front or back wheels of the vehicle 1 may be rotated, thereby steering the vehicle 1. The control stand may include a spoke linked to a rotational shaft and a steering wheel coupled with the spoke. On the spoke, there may be an input for receiving various instructions, and the input may be implemented with mechanical buttons, switches, knobs, touch pad, touch screen, stick-type manipulation device, trackball, or the like.

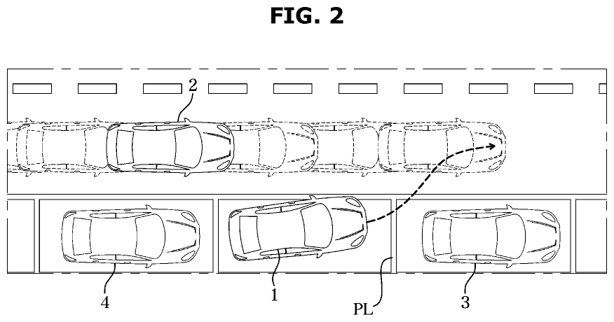

FIG. 2 is a view illustrating that the vehicle being parked is driving out of a parking line according to an exemplary embodiment. Referring to FIG. 2, the vehicle 1 (e.g., subject vehicle) is parked in a parking line PL of the parking area and other vehicles 3 and 4 are parked on the front side and the rear side of the vehicle 1. There is a risk of collision with a target vehicle 2 (e.g., a first target vehicle) driving on the rear lateral side of the vehicle 1 when the vehicle 1 exits from the parking area. However, according to the conventional RCCA, when an approach angle of the target vehicle 2 approaching the vehicle 1 is substantially parallel to the vehicle 1 as illustrated in FIG. 2, the collision is unable to be prevented since the vehicle 1 is unable to detect the target vehicle 2 as a collision risk vehicle.

Further, when the other vehicle 3 (e.g., second target vehicle or a first obstacle) is parked in front of the vehicle 1, the steering angle of the steering wheel may be detected to be greater than that in the case of ordinary driving and thus, the vehicle 1 may be driven out of the parking line PL while avoiding the other vehicle 3 to exit from the parking area. When the vehicle 1 is not parked in the parking line PL as illustrated in FIG. 2 but is parked on the shoulder of the road and then enters the road and drives, since the steering angle of the steering wheel is detected differently from the case of the driving type of the vehicle 1 in FIG. 2, it is necessary to perform collision avoidance control differently based on the driving type of the vehicle 1.

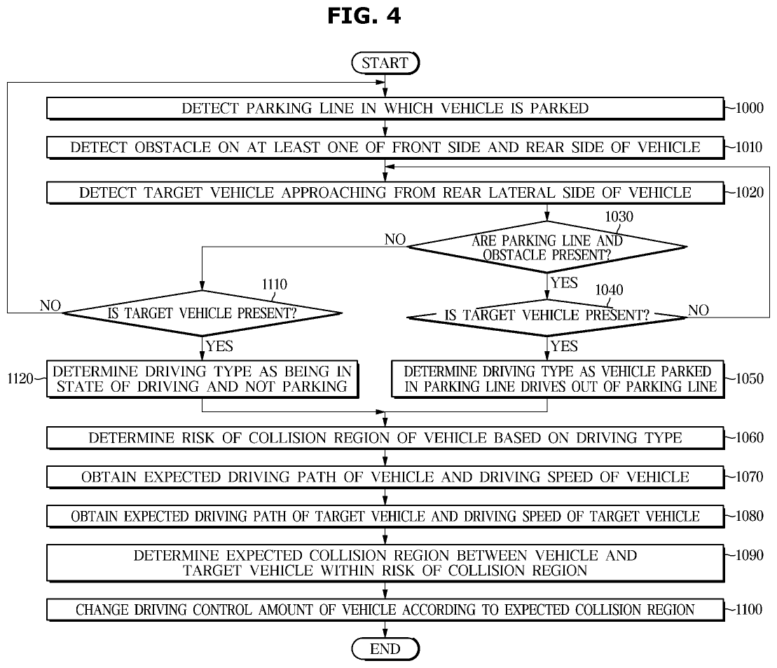

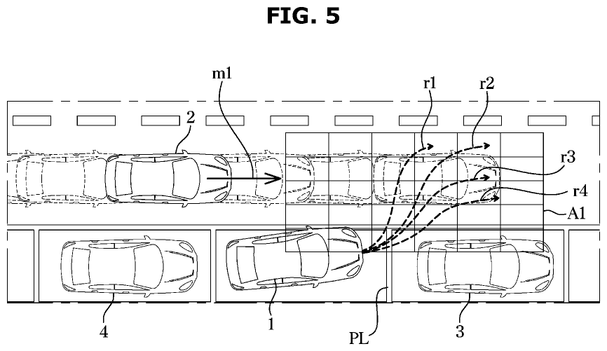

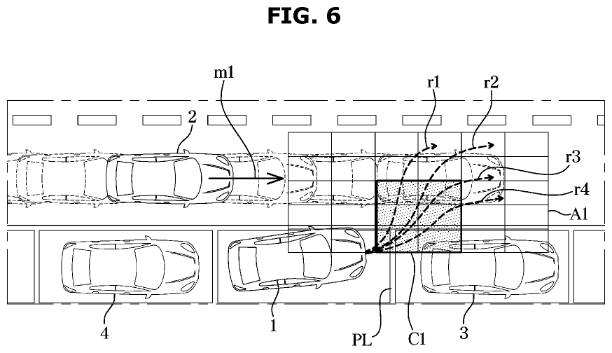

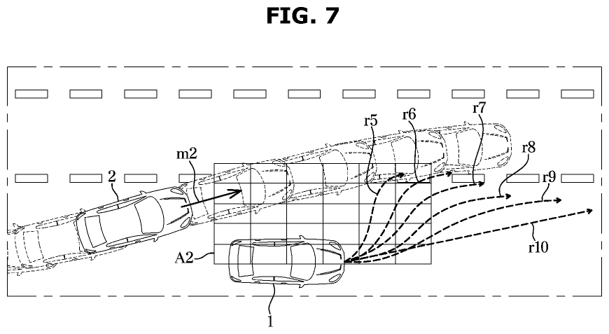

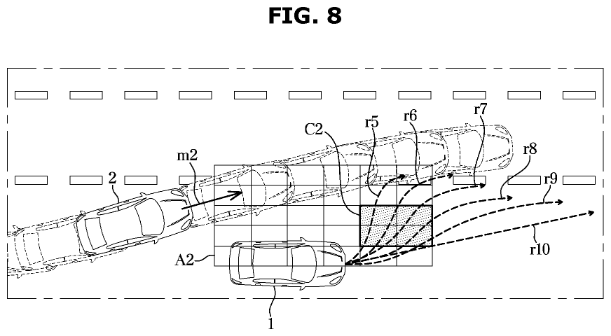

FIG. 3 is a control block diagram of the vehicle according to an exemplary embodiment, and FIG. 4 is a flowchart illustrating a method for controlling the vehicle according to an exemplary embodiment. FIG. 5 is a view illustrating determining a risk of collision region of the vehicle when the vehicle is driving out of the parking line according to an exemplary embodiment, and FIG. 6 is a view illustrating determining an expected collision region between the vehicle and a target vehicle within the risk of collision region of FIG. 5 according to an exemplary embodiment. FIG. 7 is a view illustrating determining the risk of collision region of the vehicle when a non-parked vehicle is driving according to an exemplary embodiment, and FIG. 8 is a view illustrating determining the expected collision region between the vehicle and the target vehicle within the risk of collision region of FIG. 7 according to an exemplary embodiment.

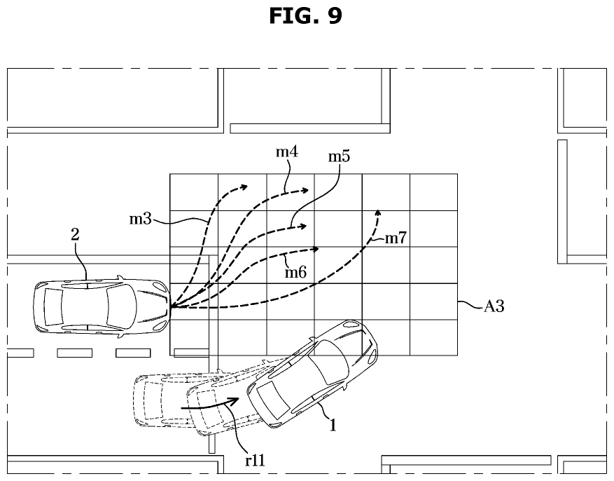

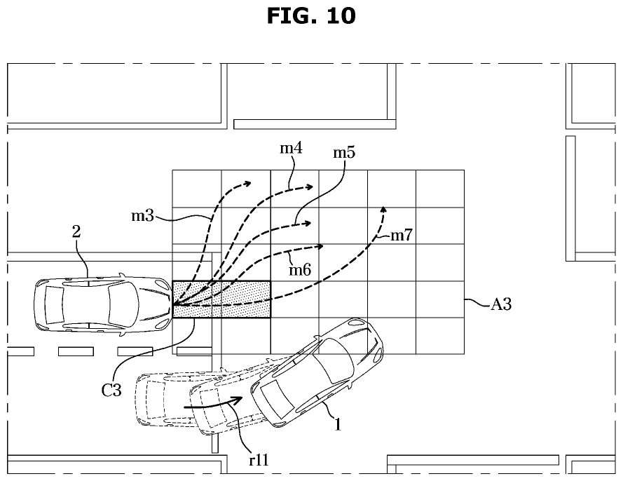

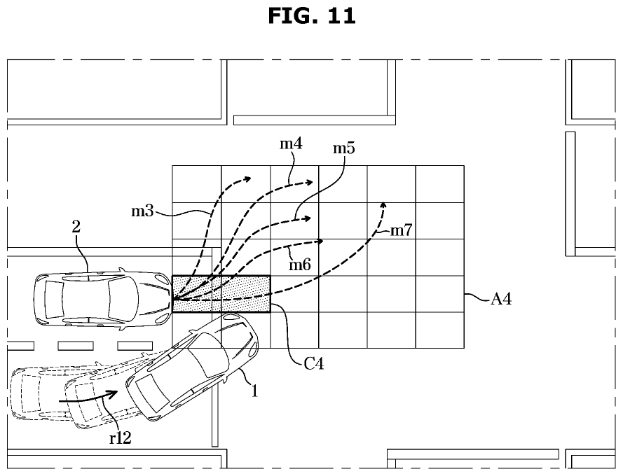

FIG. 9 is a view illustrating determining the risk of collision region of the vehicle when the vehicle makes a left turn or a U-turn according to an exemplary embodiment, FIG. 10 is a view illustrating determining the expected collision region between the vehicle and the target vehicle within the risk of collision region of FIG. 9 according to an exemplary embodiment, and FIG. 11 is a view illustrating determining the expected collision region between the vehicle and the target vehicle within the risk of collision region of FIG. 9 according to another exemplary embodiment.

Referring to FIG. 3, the vehicle 1 may include, a speed regulator 70 configured to regulate a driving speed of the vehicle 1 driven by the driver, a speed detector 80 configured to detect the driving speed of the vehicle 1, a steering angle detector 85 configured to detect a rotation angle of the steering wheel, an indicator 88 configured to provide warning notifications related to collision of the vehicle 1 to the driver, a storage 90 configured to store data related to the operation of the vehicle 1, and the controller 100 configured to operation each component of the vehicle 1 and adjust the driving speed of the vehicle 1.

In particular, the speed regulator 70 may be configured to regulate the speed of the vehicle 1 driven by the driver. The speed regulator 70 may include an accelerator driver 71 and a brake driver 72. The accelerator driver 71 may be configured to increase the speed of the vehicle 1 by operating the accelerator in response to the control signal of the controller 100. The brake driver 72 may be configured to reduce the speed of the vehicle 1 by operating the brake in response to the control signal of the controller 100. In other words, the controller 100 may be configured to operate the speed regulator 70 to change the braking amount of the vehicle 1.

The controller 100 may be configured to increase or decrease the driving speed of the vehicle 1 to increase or decrease the distance between the vehicle 1 and the object based on the distance between the vehicle 1 and the object and a predetermined reference distance stored in the storage 90. The controller 100 may also be configured to calculate a time to collision (TTC) between the vehicle 1 and the object based on a relative distance and a relative speed between the vehicle 1 and the object, and transmit a signal for adjusting the driving speed of the vehicle 1 to the speed regulator 70 based on the calculated TTC.

The speed regulator 70 may be configured to regulate the driving speed of the vehicle 1 under the control of the controller 100. When the risk of collision between the vehicle 1 and another object is high, the speed regulator 70 may be configured to decrease the driving speed of the vehicle 1. The speed detector 80 may be configured to detect the driving speed of the vehicle 1 driven by the driver under the control of the controller 100. In other words, the speed detector 80 may be configured to detect the driving speed using a rotation speed of the vehicle wheel, wherein the driving speed may be expressed as [kph], and a distance (km) traveled per unit time (h). The steering angle detector 85 may be configured to detect the steering angle, which is a rotation angle of the steering wheel while the vehicle 1 is driven. When the driver starts steering the vehicle 1 to avoid a forward object while driving the vehicle 1 by manipulating the steering wheel, the steering angle detector 85 may be configured to obtain and transmit the steering angle information of the steering wheel to the controller 100.

As described above in FIG. 2, when the other vehicle 3 (e.g., second target vehicle) is parked on the front side of the parked subject vehicle 1, the driver of the vehicle 1 may manipulate the steering wheel at a predetermined rotation angle to avoid the other vehicle 3 and to exit the parking area and thus, the steering angle detector 85 may be configured to detect the steering angle of the steering wheel. The storage 90 may be configured to store various data related to the control of the vehicle 1. Particularly, according to an exemplary embodiment, the storage 90 or memory may be configured to store information related to the driving speed, a driving distance, and a driving time of the vehicle 1, and further store the type and position information of the object detected by the capturer 350 within the controller.

Further, the storage 90 may be configured to store the position information and the speed information of the object detected by the sensor 200 and store coordinates information of the moving object changed in real time. The storage 90 may be configured to store information related to the relative distance and the relative speed between the vehicle 1 and the object. The storage 90 may also be configured to store the braking amount for adjusting the driving speed of the vehicle 1 based on the TTC between the vehicle 1 and the object and store data related to a warning time and the like for providing a warning of the collision risk to the driver of the vehicle 1.

In addition, the storage 90 may be configured to store data related to equations and control algorithms for operating the vehicle 1, and the controller 100 may be configured to transmit a control signal for operating the vehicle 1 in accordance with the equations and control algorithm. The storage 90 may also be configured to store information regarding a steering-based avoidance path established for the vehicle 1 to avoid a collision with the object located in front of the vehicle 1 and information regarding the rotation angle of the steering wheel obtained by the steering angle detector 85.

The storage 90 may be implemented using at least one of a non-volatile memory element, e.g., a cache, a Read Only Memory (ROM), a Programmable ROM (PROM), an Erasable Programmable ROM (EPROM), an Electrically Erasable Programmable ROM (EEPROM) and a flash memory; a volatile memory element, e.g., a Random Access Memory (RAM); or a storage medium, e.g., a Hard Disk Drive (HDD) and a CD-ROM. The implementation of the storage is not limited thereto. The storage 90 may be a memory that is implemented by a separate memory chip from the aforementioned processor related to the controller 100 or the storage may be implemented by a single chip with a processor.

Referring to FIG. 4, in a method for controlling a vehicle in accordance with an exemplary embodiment of the present disclosure, the capturer 350 may be configured to detect the parking line PL in the parking area where the vehicle 1 is parked (1000). The sensor 200 of the vehicle 1 may also be configured to detect the obstacle on at least one of the front side and the rear side of the vehicle 1 (1010). The rear lateral side sensor 201 may be configured to detect and sense the target vehicle 2 approaching at the rear lateral side of the vehicle 1 (1020). Particularly, the sensor 200 of the vehicle 1 may be configured to detect the other vehicle 3 parked on the front side of the vehicle 1, and the rear lateral side sensor 201 may be configured to detect the other vehicle 4 parked on the rear side of the vehicle 1.

As will be described with reference to FIGS. 5 to 8, the controller 100 may be configured to determine the driving type of the vehicle 1 based on whether the parking line PL is present around the vehicle 1 and whether there is the obstacle present on at least one of the front side and the rear side of the vehicle 1. First, the controller 100 may be configured to determine whether the parking line PL is present around the vehicle 1 based on the capturing result of the capturer 350, and the controller 100 may be configured to determine whether the obstacle is present on at least one of the front side and the rear side of the vehicle 1 based on the detection result of the sensor 200 (1030).

In addition, the controller 100 may be configured to determine whether the target vehicle 2 is approaching the rear lateral side of the vehicle 1 based on the detection result of the rear lateral side sensor 201 (1040). When the parking line PL around the vehicle 1 is present and the other vehicles 3 and 4 (e.g., second and third target vehicles or first and second obstacles) parked on at least one of the front side and the rear side of the vehicle 1 are present, and the target vehicle 2 approaching at the rear lateral side of the vehicle 1 is present, the controller 100 may be configured to determine the driving type of the vehicle 1 as that the vehicle 1 was parked in the parking line PL and then exits out of the parking line PL as illustrated in FIGS. 5 and 6 (1050).

In other words, as illustrated in FIG. 5, there is a risk of collision with the target vehicle 2 driving in the driving lane when the vehicle 1 parked in the parking line PL avoids the other vehicle 3 (e.g., second target vehicle) parked on the front side and enters a driving lane out of the parking area. Particularly, as described above, when the vehicle 1 exits the parking line PL, it is necessary to set the risk of collision region with the target vehicle 2 according to the driving type of the vehicle 1 since the target vehicle 2, which is being driven in the driving lane substantially in parallel with an exit angle of the vehicle 1, is not determined as a collision risk vehicle.

The controller 100 may be configured to determine a risk of collision region A1 between the vehicle 1 and the target vehicle 2 according to the driving type of the vehicle 1 (1060). In particular, the controller 100 may be configured to determine the risk of collision region A1 of the vehicle 1 based on the steering angle of the vehicle 1 that varies depending on the driving type of the vehicle 1 and a driving path m1 of the target vehicle 2 approaching from the rear lateral side of the vehicle 1. In other words, when the parked vehicle 1 avoids the other vehicle 3 (e.g., second target vehicle) parked on the front side and exits the parking area as compared with when the other vehicle 3 parked on the front side of the vehicle 1 does not exist, the steering angle of the steering wheel detected by the steering angle detector 85 may be detected.

The driving path of the target vehicle 2 may also be determined based on whether the other vehicle 4 (e.g., a third target vehicle) is parked on the rear side of the vehicle 1 since the target vehicle 2 drives on the driving path m1 on which the target vehicle 2 is unable to drive from the rear side of the vehicle 1 but avoids the other vehicle 4 and drives when the other vehicle 4 is parked on the rear side of the vehicle 1. Accordingly, when the current vehicle 1 is parked and then exits the parking line PL and the target vehicle 2 enters the driving lane while the vehicle 1 is being driven, the controller 100 may be configured to determine the risk of collision region A1 based on the steering angle of the vehicle 1 and the driving path m1 of the target vehicle 2.

Particularly, the controller 100 may be configured to determine the risk of collision region A between the vehicle and the target vehicle 2 based on the driving path of the vehicle 1 according to the steering angle of the vehicle 1 and the driving speed of the target vehicle 2 detected by the rear lateral side sensor 201. In other words, the controller 100 may be configured to determine the risk of collision region A1 between the vehicle and the target vehicle 2 according to the TTC calculated based on an exit direction of the vehicle 1 that has parked and the driving speed of the target vehicle 2 approaching from the rear lateral side.

Accordingly, when the vehicle 1 is parked in the parking line PL and exits the parking area, the controller 100 may give a predetermined weight to the parking line PL information captured by the capturer 350, the position information of the other vehicles 3 and 4 parked on at least one of the front side and the rear side of the vehicle 1, and detection information of the target vehicle 2 detected by the rear lateral side sensor 201, and may be configured to determine the risk of collision region A1 based on the weighted information in determining the risk of collision region A1 of the vehicle 1.

Referring to FIG. 6, the controller 100 may be configured to determine an expected collision region C1 between the vehicle 1 and the target vehicle 2 within the risk of collision region A1 based on the driving information of the vehicle 1 and the driving information of the target vehicle 2. Particularly, the driving information of the vehicle 1 may include information regarding an expected driving path of the vehicle 1 and the driving speed of the vehicle 1.

The controller 100 may be configured to obtain data regarding the expected driving path of the vehicle 1 based on steering angle data of the steering wheel detected by the steering angle detector 85 of the vehicle 1, and the controller 100 may be configured to operate the speed detector 80 to obtain driving speed data of the vehicle 1 in real time (1070). In other words, as illustrated in FIG. 6, the expected driving path of the vehicle 1 may be determined as r1, r2, r3 and r4 based on the operation of the steering wheel for avoiding the other vehicle 3 located on the front side of the vehicle 1 and exiting the parking line PL. However, the expected driving path of the vehicle 1 may change depending on the steering angle based on the operation of the steering wheel and the driving speed of the vehicle 1.

The driving information of the target vehicle 2 may also include information regarding the expected driving path of the target vehicle 2 and the driving speed of the target vehicle 2. The controller 100 may be configured to obtain the expected driving path of the target vehicle 2 and the driving speed information of the target vehicle 2 based on the change in the real-time position of the target vehicle 2 detected by the rear lateral side sensor 201 (1080).

As illustrated in FIG. 6, the target vehicle 2 may drive while avoiding the other vehicle 4 parked on the rear side of the vehicle 1 as illustrated in FIG. 5, and the controller 100 may be configured to determine the expected driving path m1 of the target vehicle 2. Additionally, the controller 100 may be configured to determine the expected collision region C1 between the vehicle 1 and the target vehicle 2 within the risk of collision region A1 based on the driving information of the vehicle 1 and the driving information of the target vehicle 2 obtained in the manner as described above (1090).

In other words, the controller 100 may be configured to determine the risk of collision region A1 of the vehicle 1 based on the parking line PL around the vehicle 1 captured by the capturer 350, the obstacle located on at least one of the front side and the rear side of the vehicle 1 detected by the sensor 200, and information of the target vehicle 2 detected by the rear lateral side sensor 201, and may be configured to determine the expected collision region C1 in which the vehicle 1 and the target vehicle 2 are in actual collision within the risk of collision region A1 based on the driving information of the vehicle 1 and the driving information of the target vehicle 2.

Conventionally, under the same conditions as the exemplary embodiment of FIGS. 5 and 6, the collision avoidance control of the vehicle 1 is performed even when a collision is unable to be prevented since the target vehicle 2 approaching from the rear lateral side of the vehicle 1 is not detected as the collision risk vehicle or a collision with the vehicle 1 is not expected based on the actual driving path of the target vehicle 2. However, the present disclosure may prevent erroneous control of the collision avoidance control of the vehicle 1 and the target vehicle 2 by determining the expected collision region C1 in which a collision between the vehicle 1 and the target vehicle 2 is actually expected based on the driving information of the vehicle 1 and the driving information of the target vehicle 2 within the risk of collision region A1 between the vehicle 1 and the target vehicle 2 and may also prevent unnecessary control.

Particularly, the controller 100 may be configured to change the driving control amount of the vehicle 1 based on the expected collision region C1 determined as illustrated in FIG. 6 (1100). In other words, the controller 100 may be configured to set the weight for the collision avoidance control to be higher than a predetermined value with respect to the expected collision region C1 in the risk of collision region A1. The controller 100 may be configured to operate the speed regulator 70 to decrease the driving speed of the vehicle 1 in response to determining that the vehicle 1 is being driven in the expected collision region C1.

Further, in response to determining that the vehicle 1 is being driven in the expected collision region C1, the controller 100 may be configured to increase the driving braking amount of the vehicle 1 within the expected collision region C1 beyond the predetermined value, and advance a collision warning time of the vehicle 1 by the predetermined time with respect to the expected collision region C 1. In other words, when it is expected that the vehicle 1 and the target vehicle 2 will collide in the expected collision region C1, the controller 100 may be configured to increase the braking amount of the vehicle 1 greater than the predetermined value according to the weight given in advance in the expected collision region C1, advance the braking time by the predetermined time, and provide a collision warning to a driver in advance by the predetermined time.

Meanwhile, the collision warning of the vehicle 1 may be provided to the driver through the indicator 88. In other words, the controller 100 may be configured to operate the indicator 88 to output a collision risk warning sound between the vehicle 1 and the target vehicle 2 to inform the driver of the risk, and may be configured to display a collision risk message on the display of the vehicle 1 to inform the driver of the risk visually. On the other hand, the controller 100 may be configured to set the weight for the collision avoidance control to be less than the predetermined value with respect to the remaining regions except for the expected collision region C1 within the risk of collision region A1.

Accordingly, when the vehicle 1 is driven to a region other than the expected collision region C1, the controller 100 may be configured to decrease the braking amount of the vehicle 1 to less than the predetermined value, delay the braking time by the predetermined time, and delay the collision warning time by the predetermined time. In other words, according to an exemplary embodiment of the disclosure, the expected collision region C1 between the vehicle 1 and the target vehicle 2 may be determined, the weight is given to the determined region, and the collision avoidance control amount of the vehicle 1 may be changed according to the given weight.

Referring again to FIG. 4, the controller 100 may be configured to determine whether the parking line PL is present around the vehicle 1 based on the capturing result of the capturer 350, and the controller 100 may be configured to determine whether the obstacle is present on at least one of the front side and the rear side of the vehicle 1 based on the detection result of the sensor 200 (1030). In addition, the controller 100 may be configured to determine whether the target vehicle 2 approaches the rear lateral side of the vehicle 1 based on the detection result of the rear lateral side sensor 201 (1110).

When the parking line PL around the vehicle 1 is not present and the other vehicles 3 and 4 parked on at least one of the front side and the rear side of the vehicle 1 are not present (e.g., no vehicles are detected on at least one of the front and rear vehicle side), and the target vehicle 2 approaches the vehicle 1 from the rear lateral side thereof, the controller 100 may be configured to determine the driving type of the vehicle 1 as a state where the vehicle 1 was not parked in the parking line PL as illustrated in FIGS. 7 and 8 (1120). In other words, in FIGS. 7 and 8, unlike the exemplary embodiment illustrated in FIGS. 5 and 6, the exemplary embodiment illustrates that the vehicle 1 is not parked in the parking line PL but stops on the shoulder of the road or a driving road side and starts driving to enter the driving lane. In other words, the vehicle is driven off the road shoulder and back into the driving lane of the road.

Particular, since the parking line PL is not captured by the capturer 350 and no other vehicle is parked on at least one of the front side and the rear side of the vehicle 1, the controller 100 may be configured to determine the driving type of the vehicle 1 as the vehicle 1 enters the lane without being parked (1120). On the other hand, as illustrated in FIG. 7, when the vehicle 1 is stopped on the shoulder of the road or a driving road side and enters the driving lane, there is a risk of collision with the target vehicle 2 approaching from the rear lateral side of the vehicle 1.

In other words, in FIG. 7, although the vehicle 1 avoids the parked other vehicle 3 (e.g., the parked second target vehicle) and enters the lane as illustrated in FIGS. 5 and 6, there is a risk of collision with the target vehicle 2 approaching the rear lateral side of the vehicle 1 and driving on the side surface of the vehicle 1 (e.g., driving next to the subject vehicle). The controller 100 may be configured to determine a risk of collision region A2 between the vehicle 1 and the target vehicle 2 based on the determined driving type of the vehicle 1 as illustrated in FIG. 7 (1060). The controller 100 may be configured to determine the risk of collision region A2 of the vehicle 1 based on the steering angle of the vehicle 1 that varies based on the driving type of the vehicle 1 as illustrated in FIG. 7 and a driving path m2 of the target vehicle 2 approaching from the rear lateral side of the vehicle 1.

When the other vehicle 3 in not parked on the front side of the vehicle 1 compared with when the parked vehicle 1 avoids the other vehicle 3 and exits the parking area, the steering angle of the steering wheel detected by the steering angle detector 85 may be detected to be minimal. The driving path of the target vehicle 2 may also be determined based on whether the other vehicle 4 parked on the rear side of the vehicle 1 is present (e.g., whether the parked third target vehicle is present at the rear of the subject vehicle). Unlike the cases illustrated in FIGS. 5 and 6, this is because the target vehicle 2 is being driven on the driving path m2 for avoiding the vehicle 1 when the other vehicle 4 is not parked on the rear side of the vehicle 1.

Accordingly, when the current vehicle 1 is stopped on the shoulder of the road or the driving road side and enters the driving lane, the controller 100 may be configured to determine the risk of collision region A2 based on the steering angle of the vehicle 1 and the driving path m2 of the target vehicle 2. Particularly, the controller 100 may be configured to determine the risk of collision region A2 between the vehicle and the target vehicle 2 based on the driving path of the vehicle 1 according to the steering angle of the vehicle 1 and the driving speed of the target vehicle 2 detected by the rear lateral side sensor 201. In other words, the controller 100 may be configured to determine the risk of collision region A2 between the vehicle and the target vehicle 2 according to the TTC calculated based on an exit direction of the vehicle 1 that has stopped on the shoulder of the road or the driving road side and the driving speed of the target vehicle 2 approaching from the rear lateral side.

In this way, when the vehicle 1 is stopped on the shoulder of the road or the driving road side and enters the driving lane, since there is no information regarding the parking line PL captured by the capturer 350 and no position information of the other vehicles 3 and 4 parked on at least one of the front side and the rear side of the vehicle 1, the controller 100 does not give the weight to the parking line PL information (e.g., does not consider this information since it is not relevant) and the position information of the other vehicles 3 and 4 but gives the predetermined weight to the detection information of the target vehicle 2 detected by the rear lateral side sensor 201. In other words, the controller 100 may be configured to determine the risk of collision region A2 based on the detection information of the weighted target vehicle 2 in determining the risk of collision region A2 of the vehicle 1.

Referring to FIG. 8, the controller 100 may be configured to determine an expected collision region C2 between the vehicle 1 and the target vehicle 2 within the risk of collision region A2 based on the driving information of the vehicle 1 and the driving information of the target vehicle 2. Particularly, the driving information of the vehicle 1 may include information regarding an expected driving path of the vehicle 1 and the driving speed of the vehicle 1.

The controller 100 may be configured to obtain data on the expected driving path of the vehicle 1 in accordance with steering angle data of the steering wheel detected by the steering angle detector 85 of the vehicle 1. Additionally, the controller 100 may be configured to operate the speed detector 80 to obtain driving speed data of the vehicle 1 in real time (1070). In other words, as illustrated in FIG. 8, the expected driving path of the vehicle 1 may be determined as r5, r6, r7, r8, r9 and r10 in accordance with the operation of the steering wheel for entering the driving lane of the vehicle 1 which is stopped on the shoulder of the road or the driving road. However, the expected driving path of the vehicle 1 may change depending on the steering angle based on the operation of the steering wheel and the driving speed of the vehicle 1.

The driving information of the target vehicle 2 may also include information regarding the expected driving path of the target vehicle 2 and the driving speed of the target vehicle 2. The controller 100 may be configured to obtain the expected driving path of the target vehicle 2 and the driving speed information of the target vehicle 2 based on the change in the real-time position of the target vehicle 2 detected by the rear lateral side sensor 201 (1080).

As illustrated in FIG. 8, the target vehicle 2 may drive from the rear side of the vehicle 1 to avoid the vehicle 1 and drive to the side surface of the vehicle 1 as illustrated in FIG. 6, and the controller 100 may be configured to determine the expected driving path m2 of the target vehicle 2. In addition, the controller 100 may be configured to determine the expected collision region C2 between the vehicle 1 and the target vehicle 2 within the risk of collision region A2 based on the driving information of the vehicle 1 and the driving information of the target vehicle 2 obtained in the manner as described above (1090).

In other words, the controller 100 may be configured to determine the risk of collision region A2 of the vehicle 1 based on the driving type of the vehicle 1 and information of the target vehicle 2 detected by the rear lateral side sensor 201, and determine the expected collision region C2 in which the vehicle 1 and the target vehicle 2 are in actual collision within the risk of collision region A2 based on the driving information of the vehicle 1 and the driving information of the target vehicle 2.

Conventionally, under the same conditions as the exemplary embodiment of FIGS. 7 and 8, the collision avoidance control of the vehicle 1 is performed even when a collision is unable to be prevented since the target vehicle 2 approaching from the rear lateral side of the vehicle 1 is not detected as the collision risk vehicle or a collision with the vehicle 1 is not expected according to the actual driving path of the target vehicle 2. However, the present disclosure may prevent erroneous control of the collision avoidance control of the vehicle 1 and the target vehicle 2 by determining the expected collision region C2 in which a collision between the vehicle 1 and the target vehicle 2 is actually expected based on the driving information of the vehicle 1 and the driving information of the target vehicle 2 within the risk of collision region A2 between the vehicle 1 and the target vehicle 2 and may also prevent unnecessary control.

Particularly, the controller 100 may be configured to change the driving control amount of the vehicle 1 based on the expected collision region C2 determined as illustrated in FIG. 8 (1100). In other words, the controller 100 may be configured to set the weight for the collision avoidance control to be higher than a predetermined value with respect to the expected collision region C2 in the risk of collision region A2. The controller 100 may be configured to operate the speed regulator 70 to decrease the driving speed of the vehicle 1 in response to determining that the vehicle 1 is being driven in the expected collision region C2.

Further, in response to determining that the vehicle 1 is being driven in the expected collision region C2, the controller 100 may be configured to increase the driving braking amount of the vehicle 1 within the expected collision region C2 to be greater than the predetermined value, and advance the collision warning time of the vehicle 1 by the predetermined time with respect to the expected collision region C2. In other words, when it is expected that the vehicle 1 and the target vehicle 2 will collide in the expected collision region C2, the controller 100 may be configured to increase the braking amount of the vehicle 1 to greater than the predetermined value according to the weight given in advance in the expected collision region C2, advance the braking time by the predetermined time, and provide a collision warning to a driver in advance by the predetermined time.

Meanwhile, the collision warning of the vehicle 1 may be provided to the driver through the indicator 88. In other words, the controller 100 may be configured to operate the indicator 88 to output a collision risk warning sound between the vehicle 1 and the target vehicle 2 to inform the driver of the risk. Additionally, the controller 100 may be configured to operate the indicator 88 to display a collision risk message on the display of the vehicle 1 to inform the driver of the risk visually. On the other hand, the controller 100 may set the weight for the collision avoidance control to be less than the predetermined value with respect to the remaining regions except for the expected collision region C2 within the risk of collision region A2.

Accordingly, when the vehicle 1 is driven to a region other than the expected collision region C2, the controller 100 may be configured to decrease the braking amount of the vehicle 1 to less than the predetermined value, delay the braking time by the predetermined time, and delay the collision warning time by the predetermined time. In other words, according to an exemplary embodiment of the disclosure, the expected collision region C2 between the vehicle 1 and the target vehicle 2 may be determined, the weight is given to the determined region, and the collision avoidance control amount of the vehicle 1 may be changed according to the given weight.

Referring to FIGS. 9 to 11, according to the exemplary embodiment, the controller 100 may be configured to perform the collision avoidance control of the vehicle 1 when a collision between the vehicle 1 and the target vehicle 2 is expected when the vehicle 1 makes a left turn or makes a U-turn while being driven. The capturer 350 of the vehicle 1 may be configured to detect the lane on which the vehicle 1 is being driven and the rear lateral side sensor 201 may be configured to detect the target vehicle 2 approaching the rear lateral side of the vehicle 1.

Additionally, the controller 100 may be configured to determine whether a surrounding lane of the vehicle 1 is present based on the capturing result of the capturer 350 (e.g., whether another driving lane is present), and the controller 100 may be configured to determine whether there is the target vehicle 2 approaching from the rear lateral side of the vehicle 1 based on the detection result of the rear lateral side sensor 201. The controller 100 may be configured to determine that the driving type of the vehicle 1 is a state in which the vehicle is being driven on a general road as illustrated in FIGS. 9 to 11, when driving lanes around the vehicle 1 and the target vehicle 2 approaching from the rear lateral side of the vehicle 1 are detected.

In other words, in FIGS. 9 to 11, the exemplary embodiment illustrates that the vehicle 1 is driven on the road and the vehicle 1 makes the left turn or the U-turn at the position at an intersection. Particularly, since the lane is detected by the capturer 350 and the target vehicle 2 approaching the rear lateral side of the vehicle 1 is detected by the rear lateral side sensor 201, the controller 100 may be configured to determine the driving type by the vehicle 1 being a state of making the left turn or the U-turn according to the detected steering angle by the steering angle detector 85. Therefore, there is a risk of collision with the target vehicle 2 approaching from the rear lateral side of the vehicle 1 when the vehicle 1 makes the left turn or the U-turn.

In particular, the controller 100 may be configured to determine a risk of collision region A3 between the vehicle 1 and the target vehicle 2 according to the driving type of the vehicle 1 making the left turn or the U-turn. At this time, the controller 100 may be configured to determine the risk of collision region A3 of the vehicle 1 based on a driving path r11 of the vehicle 1 making the left turn or the U-turn based on the steering angle of the vehicle 1 detected by the steering angle detector 85 and the driving path of the target vehicle 2 approaching from the rear lateral side of the vehicle 1.

When the operation of the steering wheel is input from the driver during the driving of the vehicle 1, the controller 100 may be configured to compare the steering angle that corresponds to the operation of the steering wheel with a reference value stored in advance in the storage 90 and determine that the vehicle 1 makes the left turn or the U-turn according to the comparison result. In other words, the controller 100 may be configured to determine the driving path of the vehicle 1 that makes the left turn or the U-turn according to the steering wheel operation of the driver.

The driving path of the target vehicle 2 approaching the rear lateral side of the vehicle 1 may be determined by various paths such as m3, m4, m5, m6 and m7 as illustrated in FIG. 9 based on the steering wheel operation of the driver. Similarly to the vehicle 1, the target vehicle 2 may make the left turn or the U-turn at the intersection, and may determine the driving path for avoiding the vehicle 1. Accordingly, when the vehicle 1 makes the left turn or the U-turn, the controller 100 may be configured to determine the risk of collision region A3 based on the driving path r11 based on the steering angle of the vehicle 1 and the driving paths m3 to m7 of the target vehicle 2 approaching from the rear lateral side.

Particularly, the controller 100 may be configured to determine the risk of collision region A3 between the vehicle and the target vehicle 2 based on the left turn or the U-turn in the driving path of the vehicle 1 based on the steering angle of the vehicle 1 and the driving path of the target vehicle 2 determined based on the driving speed of the target vehicle 2 detected by the rear lateral side sensor 201. In other words, the controller 100 may be configured to determine the risk of collision region A3 between the vehicle 1 and the target vehicle 2 according to the TTC calculated based on the left turn or the U-turn direction of the vehicle 1 or the driving road side and the driving speed of the target vehicle 2 approaching from the rear lateral side.

Accordingly, when the vehicle 1 being driven in the road lane makes the left turn or the U-turn, since there is no information of the parking line PL captured by the capturer 350 and no position information of the other vehicles 3 and 4 parked on at least one of the front side and the rear side of the vehicle 1, the controller 100 does not give the weight to the parking line PL information and the position information of the other vehicles 3 and 4 (e.g., does not consider this information since it is not relevant). However, the controller 100 may give the predetermined weight to the information regarding the driving lane detected by the capturer 350 and the detection information of the target vehicle 2 detected by the rear lateral side sensor 201. In other words, the controller 100 may be configured to determine the risk of collision region A3 based on the weighted lane information and the detection information of the weighted target vehicle 2 in determining the risk of collision region A3 of the vehicle 1.

Referring to FIG. 10, the controller 100 may be configured to determine an expected collision region C3 between the vehicle 1 and the target vehicle 2 within the risk of collision region A3 based on the driving information of the vehicle 1 and the driving information of the target vehicle 2. Particularly, the driving information of the vehicle 1 may include information regarding an expected driving path of the vehicle 1 and the driving speed of the vehicle 1.

The controller 100 may be configured to obtain data on the expected driving path of the vehicle 1 that turns left or U-turns based on steering angle data of the steering wheel detected by the steering angle detector 85 of the vehicle 1, and the controller 100 may be configured to operate the speed detector 80 to obtain driving speed data of the vehicle 1 in real time. As illustrated in FIG. 10, the expected driving path of the vehicle 1 may be determined as the driving path r11 based on the operation of the steering wheel for turning left or U-turning the vehicle 1 in the driving state. However, the expected driving path of the vehicle 1 may change depending on the steering angle based on the operation of the steering wheel and the driving speed of the vehicle 1.

The driving information of the target vehicle 2 may also include information regarding the expected driving path of the target vehicle 2 and the driving speed of the target vehicle 2. The controller 100 may be configured to obtain the expected driving path of the target vehicle 2 and the driving speed information of the target vehicle 2 based on the change in the real-time position of the target vehicle 2 detected by the rear lateral side sensor 201.

As illustrated in FIG. 10, the target vehicle 2 may drive from the side lane of the vehicle 1 to the rear side of the vehicle 1, and the controller 100 may be configured to determine the expected driving paths m3 to m7 of the target vehicle 2. Additionally, the controller 100 may be configured to determine the expected collision region C3 between the vehicle 1 and the target vehicle 2 within the risk of collision region A3 based on the driving information of the vehicle 1 and the driving information of the target vehicle 2 obtained in the manner as described above.

In other words, the controller 100 may be configured to determine the risk of collision region A3 of the vehicle 1 based on the driving type of the vehicle 1 and information of the target vehicle 2 detected by the rear lateral side sensor 201, and may be configured to determine the expected collision region C3 in which the vehicle 1 and the target vehicle 2 are in actual collision within the risk of collision region A3 based on the driving information of the vehicle 1 and the driving information of the target vehicle 2. Conventionally, as in the conditions of the exemplary embodiment of FIG. 10, the collision avoidance control of the vehicle 1 is performed even when collision with the vehicle 1 is not expected based on the actual driving path of the vehicle 1 and the target vehicle 2.

The present disclosure may prevent erroneous control of the collision avoidance control of the vehicle 1 and the target vehicle 2 by determining the expected collision region C3 in which a collision between the vehicle 1 and the target vehicle 2 is actually expected based on the driving information of the vehicle 1 and the driving information of the target vehicle 2 within the risk of collision region A3 between the vehicle 1 and the target vehicle 2 and may also prevent unnecessary control. In other words, in FIG. 10, the vehicle 1 is not driven to the expected collision region C3 since the vehicle 1 makes the left turn or the U-turn out of the expected collision region C3 determined by the controller 100. Therefore, the controller 100 does not perform the collision avoidance control of the vehicle 1 since the vehicle 1 and the target vehicle 2 will not collide in the expected collision region C3.

Meanwhile, when the controller 100 determines a risk of collision region A4 of the vehicle 1 and determines an expected collision region C4 in which the vehicle 1 and the target vehicle 2 are likely to actually collide, the controller 100 may be configured to change the driving control amount of the vehicle 1 when the vehicle 1 is driven in the expected collision region C4 and the collision with the target vehicle 2 is expected. In other words, the controller 100 may be configured to set the weight for the collision avoidance control to be higher than a predetermined value with respect to the expected collision region C4 in the risk of collision region A4.

Additionally, the controller 100 may be configured to operate the speed regulator 70 to decrease the driving speed of the vehicle 1 in response to determining that the vehicle 1 is driven in the expected collision region C4. Further, in response to determining that the vehicle 1 is being driven in the expected collision region C4, the controller 100 may be configured to increase the driving braking amount of the vehicle 1 within the expected collision region C4 beyond the predetermined value, and advance the collision warning time of the vehicle 1 by the predetermined time with respect to the expected collision region C4.

In other words, when it is expected that the vehicle 1 and the target vehicle 2 will collide in the expected collision region C4, the controller 100 may be configured to increase the braking amount of the vehicle 1 to be greater than the predetermined value according to the weight given in advance in the expected collision region C4, advance the braking time by the predetermined time, and provide a collision warning in advance by the predetermined time. Meanwhile, the collision warning of the vehicle 1 may be provided to the driver through the indicator 88. In particular, the controller 100 may be configured to operate the indicator 88 to output a collision risk warning sound between the vehicle 1 and the target vehicle 2 to inform the driver of the risk, and display a collision risk message on the display of the vehicle 1 to inform the driver of the risk visually.

On the other hand, the controller 100 may be configured to set the weight for the collision avoidance control to be less than the predetermined value with respect to the remaining regions except for the expected collision region C4 within the risk of collision region A4. Accordingly, when the vehicle 1 is driven to a region other than the expected collision region C4, the controller 100 may be configured to decrease the braking amount of the vehicle 1 to less than the predetermined value, delay the braking time by the predetermined time, and delay the collision warning time by the predetermined time. According to an exemplary embodiment of the disclosure, the expected collision region C4 between the vehicle 1 and the target vehicle 2 may be determined, the weight is given to the determined region, and the collision avoidance control amount of the vehicle 1 may be changed based on the given weight.

As described above, according to the vehicle and the method for controlling the vehicle according to the exemplary embodiment of the disclosure, there is an effect of assisting the collision avoidance system by performing the collision avoidance control under special conditions, such as when the parked vehicle exits the parking line PL while driving in parallel with another vehicle approaching in the side lane, or the vehicle 1 makes the left turn or the U-turn. In addition, erroneous control conditions related to collision avoidance that may occur during driving of the vehicle may be prevented.

Meanwhile, the exemplary embodiments of the present disclosure may be implemented in the form of recording media for storing instructions to be executed by a computer. The instructions may be stored in the form of program codes, and when executed by a processor, may generate program modules to perform operations in the exemplary embodiments of the present disclosure. The recording media may correspond to non-transitory computer-readable recording media. The non-transitory computer-readable recording medium includes any type of recording medium having data stored thereon that may be thereafter read by a computer. For example, it may be a ROM, a RAM, a magnetic tape, a magnetic disk, a flash memory, an optical data storage device, etc.

Several exemplary embodiments of the present disclosure have thus far been described with reference to the accompanying drawings. It will be obvious to those of ordinary skill in the art that the present disclosure may be practiced in forms other than the exemplary embodiments as described above without changing the technical idea or essential features of the present disclosure. The above exemplary embodiments are only by way of example, and should not be interpreted in a limited sense.

What is claimed is:

1. A vehicle, comprising:
a capturer configured to detect a parking line in which the vehicle is parked;
a sensor configured to detect an obstacle on at least one of a front side and a rear side of the vehicle, and to detect a target vehicle approaching from a rear lateral side of the vehicle; and
a controller configured to determine a driving type of the vehicle based on parking line information detected by the capturer, the detected obstacle information, and the detected target vehicle information, determine a risk of collision region of the vehicle based on the driving type, and determine an expected collision region between the vehicle and the target vehicle within the risk of collision region based on driving information of the vehicle and driving information of the target vehicle to change the driving control amount of the vehicle based on the expected collision region.

2. The vehicle according to claim 1, wherein the controller is configured to determine the driving type of the vehicle as a state in which the vehicle is parked in the detected parking line and is driven out of the parking line when the capturer detects the parking line in which the vehicle is parked and the sensor detects the obstacle and the target vehicle.

3. The vehicle according to claim 1, wherein the controller is configured to determine the driving type of the vehicle as a state of driving and not parking when the capturer does not detect the parking line in which the vehicle was parked, the sensor does not detect the obstacle, and the sensor detects the target vehicle.

4. The vehicle according to claim 1, wherein the controller is configured to determine the risk of collision region of the vehicle based on a steering angle of the vehicle that varies based on the driving type of the vehicle and a driving path of the target vehicle approaching from the rear lateral side of the vehicle, and wherein the driving path of the target vehicle is determined based on whether the obstacle is detected at the rear side of the vehicle.

5. The vehicle according to claim 1, wherein the driving information of the vehicle includes an expected driving path of the vehicle and a driving speed of the vehicle, the driving information of the target vehicle comprises an expected driving path of the target vehicle and a driving speed of the target vehicle, and the controller is configured to determine the expected driving path of the vehicle based on a steering angle of the vehicle, and determine the expected driving path of the target vehicle based on a change in the real-time position of the target vehicle detected by the sensor.

6. The vehicle according to claim 1, further comprising:
a speed regulator configured to regulate a driving speed of the vehicle,
wherein when the expected collision region between the vehicle and the target vehicle within the risk of collision region is determined, the controller is configured to operate the speed regulator to decrease the driving speed at which the vehicle is being driven in the determined expected collision region.

7. The vehicle according to claim 1, wherein when the expected collision region between the vehicle and the target vehicle within the risk of collision region is determined, the controller is configured to increase the driving braking amount of the vehicle within the determined expected collision region to greater than a predetermined value.

8. The vehicle according to claim 1, wherein when the expected collision region between the vehicle and the target vehicle within the risk of collision region is determined, the controller is configured to advance a collision warning time for the vehicle by a predetermined time.

9. The vehicle according to claim 1, further comprising:
a speed detector configured to detect a driving speed of the vehicle; and
a steering angle detector configured to detect a rotation angle of a steering wheel of the vehicle.

10. The vehicle according to claim 1, wherein the obstacle includes other vehicles parked on at least one of the front side and the rear side of the vehicle.

11. A method for controlling a vehicle, comprising:
detecting, by a controller, a parking line in which the vehicle is parked;
detecting, by the controller, an obstacle on at least one of a front side and a rear side of the vehicle;
detecting, by the controller, a target vehicle approaching from a rear lateral side of the vehicle;
determining, by the controller, a driving type of the vehicle based on the detected parking line information, the detected obstacle information, and the detected target vehicle information;
determining, by the controller, a risk of collision region of the vehicle based on the driving type;
determining, by the controller, an expected collision region between the vehicle and the target vehicle within the risk of collision region based on driving information of the vehicle and driving information of the target vehicle; and
changing, by the controller, the driving control amount of the vehicle based on the determined expected collision region.

12. The method according to claim 11, wherein the determining of the driving type of the vehicle includes:
determining, by the controller, the driving type of the vehicle as a state in which the vehicle is parked in the detected parking line and is driven out of the parking line when the parking line in which the vehicle is parked is detected and the obstacle and the target vehicle are detected.

13. The method according to claim 11, wherein the determining of the driving type of the vehicle includes:
determining, by the controller, the driving type of the vehicle as being in a state of driving and not parking when the parking line in which the vehicle was parked when the parking line in which the vehicle is parked is not detected, the obstacle is not detected, and the target vehicle is detected.

14. The method according to claim 11, wherein the determining of the risk of collision region of the vehicle includes:
determining, by the controller, the risk of collision region of the vehicle based on a steering angle of the vehicle that varies based on the driving type of the vehicle and a driving path of the target vehicle approaching from the rear lateral side of the vehicle, and
wherein the driving path of the target vehicle is configured to be determined based on whether the obstacle is detected on the rear side of the vehicle.

15. The method according to claim 11, wherein the driving information of the vehicle includes an expected driving path of the vehicle and a driving speed of the vehicle, the driving information of the target vehicle includes an expected driving path of the target vehicle and a driving speed of the target vehicle, and the method further includes:
determining, by the controller, the expected driving path of the vehicle based on a steering angle of the vehicle; and
determining, by the controller, the expected driving path of the target vehicle based on a change in the real-time position of the detected target vehicle.

16. The method according to claim 11, further comprising:
regulating, by the controller, a driving speed of the vehicle, and
wherein the changing of the driving control amount of the vehicle includes:
when the expected collision region between the vehicle and the target vehicle within the risk of collision region is determined, decreasing, by the controller, the driving speed at which the vehicle drives in the determined expected collision region.

17. The method according to claim 11, wherein the changing of the driving control amount of the vehicle includes:
when the expected collision region between the vehicle and the target vehicle within the risk of collision region is determined, increasing, by the controller, the driving braking amount of the vehicle within the determined expected collision region to greater than a predetermined value.

18. The method according to claim 11, further comprising:
when the expected collision region between the vehicle and the target vehicle within the risk of collision region is determined, advancing, by the controller, a collision warning time for the vehicle by a predetermined time.

19. The method according to claim 11, further comprising:
detecting, by the controller, a driving speed of the vehicle; and
detecting, by the controller, a rotation angle of a steering wheel of the vehicle.
